(19) United States
(12) Patent Application Publication
(10) Pub. No.: US 2016/0221387 A1
(43) Pub. Date: Aug. 4, 2016

(54) Tire Rim Cover

(71) Applicant: Annette Lastrapes, Opelousas, LA (US)

(72) Inventor: Annette Lastrapes, Opelousas, LA (US)

(21) Appl. No.: 14/980,474

(22) Filed: Dec. 28, 2015

Related U.S. Application Data
(60) Provisional application No. 62/109,282, filed on Jan. 29, 2015.

(51) Int. Cl. B60B 7/04

(52) U.S. Cl. CPC B60B 7/04; B60B 2900/212

(57) ABSTRACT

A tire rim cover is provided to serve as a protective barrier for a tire rim against cleansing material used for enhancing the appearance of a wheel disposed around the tire rim. The tire rim cover includes a circular body portion having a front side, a rear side, and an outer edge. The front side includes a handle thereon that can be grasped by a user so as to manually press the rear side of the body portion against an inner edge of the wheel to enclose the tire rim. The outer edge is composed from flexible material so as to allow the body portion to be twisted into a figure “8” shape and folded in half afterwards to form a compact configuration. A pocket disposed on the rear side can receive the folded body portion therein to maintain the compact configuration for easy storage.

### CROSS REFERENCE TO RELATED APPLICATION

This application claims the benefit of U.S. Provisional Application No. 62/109,282 filed on Jan. 29, 2015. The above identified patent application is herein incorporated by reference in its entirety to provide continuity of disclosure.

### BACKGROUND OF THE INVENTION

The present invention relates to vehicle accessories. More specifically, the present invention relates to tire rim covers that protect the tire rim during car detailing.

Many people have an interest in vehicles and the customization of vehicles. One of the most popular ways to customize a vehicle is by installing a new set of tire rims. These tire rims are produced in a variety of styles, including mag wheels, modular wheels, alloy wheels, aluminum wheels, and many others. Generally to a car enthusiast, a new set of rims can vastly improve the appearance of any vehicle. However, properly caring for the new set of tire rims can be challenging.

Specifically, while detailing a car, many consumers use cleaning supplies, such as solvents and cleansers, that may leave undesirable and unattractive stains, markings or residue on the tire rims. These unattractive stains are often considered a time-consuming nuisance as additional work and extensive scrubbing is needed to remove these stains or streaks. Therefore, there exists a need for a device that provides a tire rim cover that prevents any of these cleaning supplies from damaging the tire rim while car detailing.

Devices have been disclosed in the prior art that relate to wheel covers and tire rim covers. These include devices that have been patented and published in patent application publications. These include U.S. Pat. No. 6,860,568 to Nunes and U.S. Pat. No. 6,688,703 to Wang. The Nunes device comprises a wheel rim cover for a vehicle, which comprises a cover for fastening to a wheel rim. The rim cover, however, is bolted onto the rim of the wheel. The Wang device describes a wheel rim cover comprising a spring loaded fastening means which attaches to a wheel rim and creates an elevated effect for visual appearance. These devices, however, fail to describe a pocket disposed on a rear side configured to wrap around and envelope the body portion in its compact configuration.

The present invention provides a tire rim cover configured to be placed against an inner edge of a wheel to enclose a tire rim to protect it from cleansing supplies used for enhancing the appearance of the wheel therearound. The tire rim cover includes a body portion comprising a front side, a rear side, and an outer edge. The front side includes a handle configured to be hand gripped by a user to manually press the body portion against a wheel to serve as a protective barrier for the tire rim. The outer edge is composed from a flexible material configured to allow the body portion to be twisted to form a figure “8” and fold in half afterwards to form a compact state. A pocket disposed on the rear side is adapted to wrap around and envelope the body portion in its compact configuration for easy storage.

It is therefore submitted that the present invention is substantially divergent in design elements from the prior art, and consequently it is clear that there is a need in the art for an improvement to tire rim covers. In this regard, the instant invention substantially fulfills these needs.

### SUMMARY OF THE INVENTION

In view of the foregoing disadvantages inherent in the known types of tire rim covers now present in the prior art, the present invention provides a tire rim cover wherein the same can be utilized for serving as a protective barrier for a tire rim against cleaning supplies for the wheel therearound.

It is therefore an object of the invention to provide a new and improved tire rim cover that has all of the advantages of the prior art and none of the disadvantages.

Another object of the present invention is to provide a new and improved tire rim cover having a body portion comprising a front side, a rear side, and an outer edge, configured to be placed against an inner edge of a wheel to serve as a protective barrier for a tire rim against cleansing materials for the wheel therearound.

Yet another object of the present invention is to provide a new and improved tire rim cover, wherein the front side includes a handle configured to be hand gripped by a user to manually press the rear side against an inner edge of the wheel to enclose the tire rim.

Still yet another object of the present invention is to provide a new and improved tire rim cover, wherein the outer edge is composed from flexible material that allows the body portion to be twisted in a figure “8” shape and folded down afterwards to form a compact configuration.

A further object of the present invention is to provide a new and improved tire rim cover, wherein a pocket is disposed on the rear side to wrap around and envelope the body portion in its compact state for easy transport.

Yet a further object of the present invention is to provide a new and improved tire rim cover, wherein the pocket is disposed substantially on a quadrant of the rear side.

Still yet another object of the present invention is to provide a new and improved tire rim cover wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front view of the present invention.

FIG. 2 shows a side perspective view of the present invention removably attached to a tire.

FIG. 3 shows a rear perspective view of the present invention.

FIG. 4 shows a perspective view of the present invention in a twisted configuration.

FIG. 5 shows a perspective view of the present invention twisted and folded down for easy storage.

### DETAILED DESCRIPTION OF THE INVENTION

Reference is made herein to the attached drawings. Like reference numerals are used throughout the drawings to depict like or similar elements of tire rim cover. For the purposes of presenting a brief and clear description of the present invention, the preferred embodiment will be discussed as used for enclosing a tire rim to protect the tire rim from cleansing supplies that may damage the tire rim. The figures are intended for representative purposes only and should not be considered to be limiting in any respect.

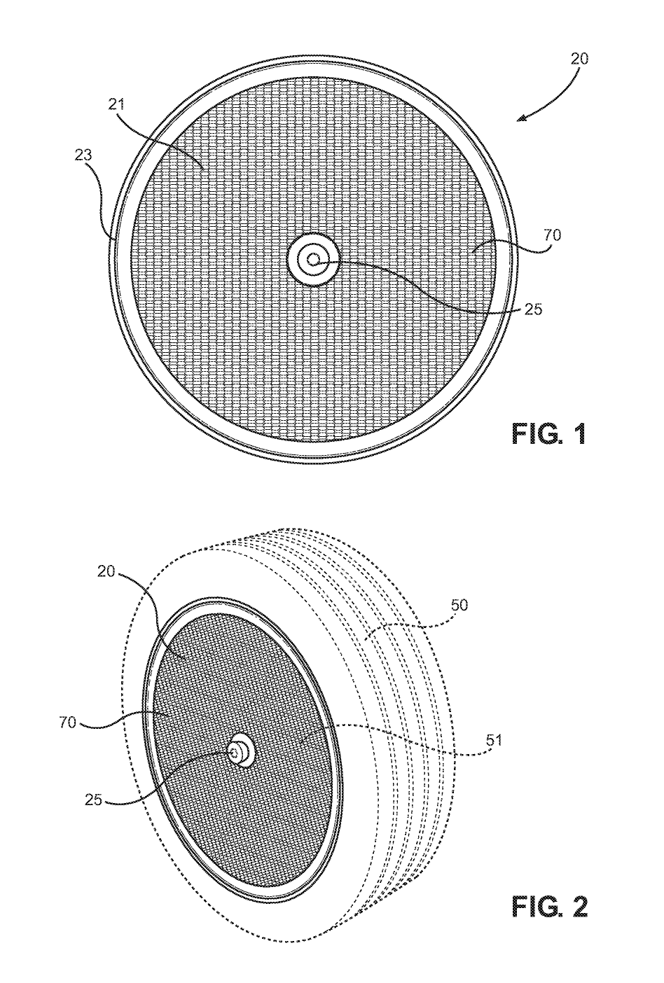

Referring now to FIGS. 1 and 2, there are shown a front view and a side perspective view of the tire rim cover. The tire rim cover 20 is a protective shield for the tire rim 51 of a wheel 50, specifically configured to protect valuable tire rims from a variety of chemicals typically used when cleaning or detailing tires. The tire rim cover 20 includes a body portion 70, preferably circular in shape to correspond to the shape of a tire rim. In addition, the tire rim cover 20 is produced in a variety of sizes appropriate for use with variously sized tire rims available on the market.

The body portion 70 includes a front side 21, a rear side, and an outer edge 23, wherein the rear side is adapted to be placed directly over a tire rim 51 and the outer edge 23 is adapted to be placed in contact against the wheel 50. In this way, the tire rim cover 20 encloses the tire rim 51. In some embodiments, the rear side includes an absorbent pad around the outer edge 23 of the body portion 70. This is particularly beneficial as the harsh chemicals and dressings used to enhance the appearance of tires will not drip onto the tire rim 51, which may leave undesirable and unattractive streaks, stains, and marks that are associated with the accidental use of the harsh chemicals and dressing on the tire rim 51. Preferably, the absorbent pad is composed from foam rubber or sponge rubber, however, other suitable material that serve as a barrier to prevent these aforementioned cleaning supplies from contacting the tire rim 51 are likewise contemplated.

In other embodiments, the absorbent pad also further includes an adhesive, preferably, a pressure sensitive adhesive, on an outer surface of the absorbent pad that allows for the absorbent pad to be removably adhered to an inner edge of the tire 50. The adhesive allows a user to not have to manually press the tire rim cover 20 against the tire rim 51. When not in use, a liner can be placed over the adhesive to prevent the adhesive from adhering on itself or other areas.

The front side 21 includes a handle 25 that is, preferably, centrally located. In the illustrated embodiment, the handle 25 is a knob that extends outward from the front side 21 of the body portion 70 of the tire rim cover 20. However other suitable handles 25 are likewise contemplated. The handle 25 is adapted to be gripped by a user to manually press the rear side against the tire rim 51.

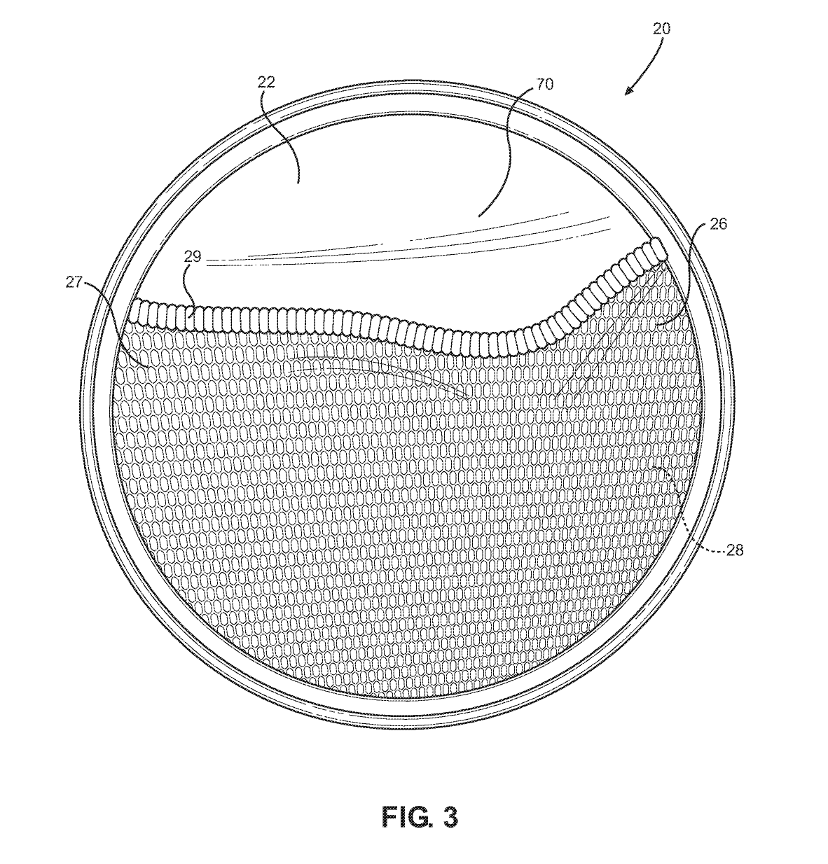

Referring now to FIG. 3, there is shown a rear perspective view of the present invention. The tire rim cover 20 comprises a pocket 26 disposed thereon. In the illustrated embodiment, the pocket 26 is disposed on the rear side 22 of the tire rim cover 20. The pocket 26 comprises a front wall 27, a rear wall 28, and an open upper end 29, defining an interior volume. In the illustrated embodiment, the rear side of the body portion 70 serves as the rear wall 28 of the pocket 26. Preferably, the front wall 27 of the pocket 26 is mesh, however, other pocket types are likewise contemplated. The front wall 27 of the pocket 26 is configured wrap around the tire rim cover 20 when the same is in a folded configuration to provide for easy storage and transport. The pocket 26 is preferably sewn thereon, other means for attaching are also contemplated.

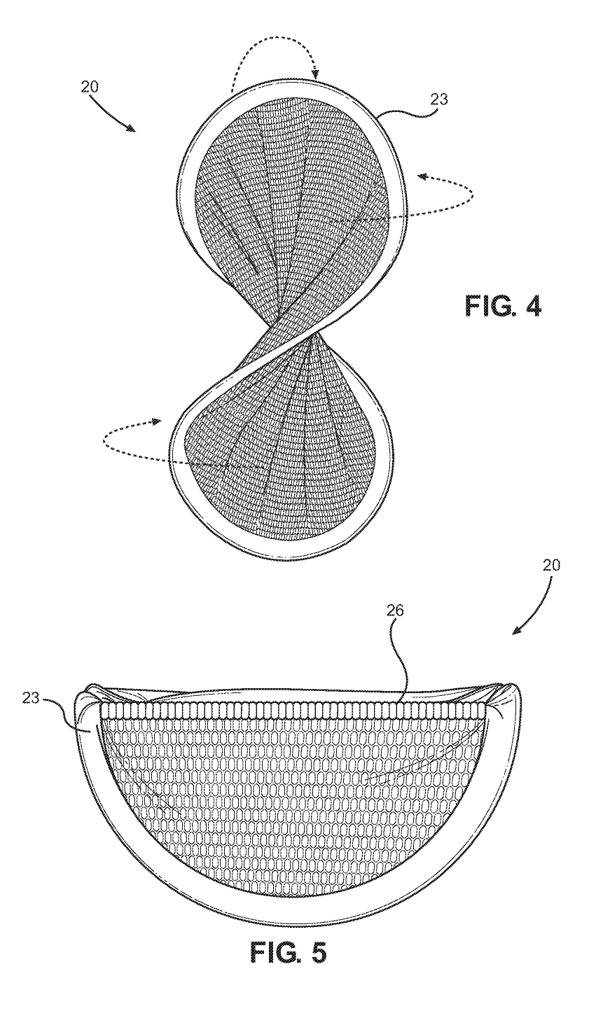

Referring now to FIGS. 4 and 5, there are shown perspective views of the tire rim cover in a twisted and folded configuration. The outer edge 23 of the tire rim cover 20 is preferably composed from flexible or malleable material, such as wire. In this way, the tire rim cover 20 can be twisted and rotated to form a figure “8” as illustrated in FIG. 4. Furthermore, the tire rim cover 20 can be folded in half, as illustrated in FIG. 5, after the tire rim cover 20 is twisted to form the figure “8.” This is particularly beneficial as the pocket 26 is designed to wrap around and envelope the tire rim cover 20 in its compact configuration. The pocket can then be pulled over and around itself to maintain the tire rim cover 20 in its compact and transportable configuration. In some embodiments, the pocket 26 is disposed on substantially a quadrant of the tire rim cover 20 so as to receive the folded configuration therein.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A tire rim cover, comprising:
a body portion having a front side, a rear side, and an outer edge adapted to be placed in contact with an inner edge of a wheel to serve as a protective barrier for a tire rim;
a handle disposed on said front side;
a pocket having a front wall, a rear wall, and an open upper end, defining an interior volume, wherein said pocket is disposed on said body portion and configured to wrap around and envelope said body portion when said body portion is in a compact configuration.

2) The tire rim cover of claim 1, wherein said body portion is circular in shape.

3) The tire rim cover of claim 1, wherein said outer edge is composed of wire, which allows the body portion to be twisted into a figure “8” shape and folded in half to form said compact configuration.

4) The tire rim cover of claim 1, wherein said pocket is disposed on said rear side and configured to maintain said body portion in said compact configuration.

5) The tire rim cover of claim 1, wherein said handle comprises a knob.

6) The tire rim cover of claim 1, wherein said pocket is composed of a mesh material.
